(19) United States
(12) Patent Application Publication
(10) Pub. No.: US 2016/0021866 A1
(43) Pub. Date: Jan. 28, 2016

(54) AIR-FLOWING TYPE MOSQUITO KILLING DEVICE

(71) Applicant: Qiwu LI, Shenzhen, Guangdong (CN)

(72) Inventor: QIWU LI, Shenzhen (CN)

(21) Appl. No.: 14/775,696

(22) PCT Filed: Feb. 21, 2014
(86) PCT No.: PCT/CN2014/072378

§ 371 Date: Sep. 12, 2015

(51) Int. Cl. A01M 1/08; A01M 1/10

(52) U.S. Cl. CPC A01M 1/08; A01M 1/106

(57) ABSTRACT

An air-flowing type mosquito killing device comprises a housing, a circuit board, a lamp, and a fan fixed in the housing by a screw. The housing corresponding to an air outlet of the fan is configured with a mosquito opening. The present disclosure use the fan fixed in the housing by the screw, which makes the fan firmly fixed in the housing because of the firm fixing of the screw. The screw is convenient to be installable or disassemble, which saves installation time, and is convenient to inspect and maintain when the failure occurs. The mosquitoes are attracted by the light, airflow generated by the fan draws the mosquitoes to the housing, and the mosquitoes are blown the mosquito opening. The fan constantly rotates, which dries the air and dehydrates the mosquitoes, thus killing the mosquito and keeping people far away from mosquito distractions.

### TECHNICAL FIELD

The present disclosure relates to the field of mosquito killing devices, and more particularly to an air-flowing type mosquito killing device.

### BACKGROUND

Mosquitoes like biting people or animals. In order to trap and kill the mosquitoes, people not only use a mosquito-repellent incense, but also use mosquito swatters, electric mosquito swatters, or direct-current type mosquito traps. People use mosquito nets to block the mosquitoes. In using mosquito-repellent incense, gas generated by the mosquito-repellent incense is harmful to human health, especially for children, pregnant women, and people with respiratory diseases. Users have to wave their hands when they use the mosquito swatters or the electric mosquito swatters, which is tiresome and bothersome, and is not effective in killing the mosquitoes. The direct current type mosquito trap uses a modulator tube, where mosquitoes are attracted by light generated by the tube. Electrically conductive coils arranged around the modulator tube emit light and electrocute the mosquitoes when the mosquitoes contact the conductive coils that are charged by direct current. The direct current type mosquito trap electrocutes the mosquito without emitting gas; it is tasteless, and automatically kills the mosquitoes, which improves mosquito killing.

However, because the direct current type mosquito trap electrocutes mosquitoes using direct current, it creates a dangerous situation for people, especially for children. Applicant has designed an air-flowing type mosquito killing device that includes a housing, a lamp arranged on the housing, a circuit board, and a fan. The housing corresponding to the fan is configured with an air inlet and an air outlet, and the housing corresponding to the air outlet is configured with a mosquito opening. The mosquito opening is a net structure, where size of through holes of the net structure is less than size of a mosquito. When the air-flowing type mosquito killing device is on, a lamp emits light to attract mosquitoes, airflow generated by the fan draws the mosquitoes to the housing, and the mosquito is blown into the mosquito opening. The fan constantly rotates, which dries the air and dehydrates the mosquitoes, and makes the mosquitoes die. The housing comprises an upper housing and a lower housing, where the upper housing and the lower housing are configured with corresponding clamping structures. The fan is arranged on positions of the clamping structures, and is fixed by fixing the upper housing and the lower housing. However, large vibrations are generated when the fan rotates, which makes the housing insecure.

### SUMMARY

The aim of the present disclosure is to provide an air-flowing type mosquito killing device capable of firmly fixing a fan.

The aim of the present disclosure is achieved by the following methods:

An air-flowing type mosquito killing device comprises a housing, a circuit board, a lamp, and a fan fixed in the housing by a screw. The housing corresponding to an air outlet of the fan is configured with a mosquito opening.

Furthermore, the housing is configured with a screw hole column. The fan is configured with a screw hole matching with the screw hole of the housing. It is a specific example that shows that the fan is fixed in the housing by the screw.

Furthermore, the fan is configured with a convex plate, and a screw hole is arranged on the convex plate, which makes the screw hole and the screw hole column convenient to match and fix.

Furthermore, a reinforcing plate is arranged on the convex plate of the fan, which improves strength of convex plate.

Furthermore, the fan is connected with the circuit board by wires, and the fan is configured with a groove, and the wires are place along the groove from an opening of the groove, which avoids wires damage if the wires touch the fan.

Furthermore, site of the opening decreases gradually and increases gradually until the size of the opening has no change to form the groove; a minimum width of the opening is less than a diameter of the wire, where the wires are placed along the groove, which prevents the wires from entering into the opening, further limiting the wires.

Furthermore, the screw hole column is configured with reinforcing ribs, and the reinforcing ribs are a triangular structures, which improves strength of the screw hole column.

Furthermore, a plurality of the reinforcing ribs are uniformly arranged on the screw hole column, which improves strength of the screw hole column.

Furthermore, the number of the screw hole columns are four and are uniformly arranged, which makes the screw hole and the screw hole column convenient to match and fix.

Furthermore, the air-flowing type mosquito killing device further comprises a protection element arranged on an air inlet of the fan, which avoids fingers of the users and children entering into the fan, further avoiding the users hurting and affecting normal operation of the fan.

The present disclosure uses the fan fixed in the housing by the screw, which makes the fan firmly fixed in the housing because of the firm fixing of the screw The screw is convenient to be installable or disassemble, which saves installation time, and is convenient to inspect and maintain when the failure occurs. The mosquitoes are attracted by the light, airflow generated by the fan draws the mosquitoes to the housing, and the mosquitoes are blew in the mosquito opening. The fan constantly rotates, which dries the air and dehydrates the mosquitoes, thus killing the mosquitoes and keeping people far away from mosquito distractions.

### BRIEF DESCRIPTION OF FIGURES

FIG. 1 is an overall schematic diagram of an air-flowing type mosquito killing device of an example of the present disclosure.

FIG. 2 is a cross-sectional schematic diagram of the air-flowing type mosquito killing device of the example of the present disclosure.

FIG. 3 is a structural diagram of an upper housing of the example of the present disclosure.

FIG. 4 is a structural diagram of a fan of the example of the present disclosure.

Legends: 1. a housing: 11. an air inlet; 12. a screw hole column; 13. a reinforcing rib; 2. a fan; 21. a screw hole; 22. a convex plate; 3. a base; 31. a mosquito opening; 4. a protection element; 5. a circuit board; 6. a switch; 7. an interstice.

### DETAILED DESCRIPTION

The present disclosure will further be described in detail in accordance with the figures and the exemplary examples.

In the present disclosure, an air-flowing type mosquito killing device comprises a housing 1, a circuit board 5, a lamp, and a fan 2 fixed in the housing 1 by a screw. The housing corresponding to an air outlet of the fan 2 is configured with a mosquito opening 31. The present disclosure fixes the fan in the housing using the screw, which firmly fixes the fan in the housing because of the firm fixing of the screw. The screw is convenient to be installable or disassemble, which saves installation time, and is convenient to inspect and maintain when failure occurs. The mosquitoes are attracted by the light, airflow generated by the fan 2 draws the mosquitoes to the housing, and the mosquitoes are blown in the mosquito opening 31. The fan constantly rotates, which dries the air and dehydrates the mosquitoes, thus killing the mosquitoes and keeping people far away from mosquito distractions.

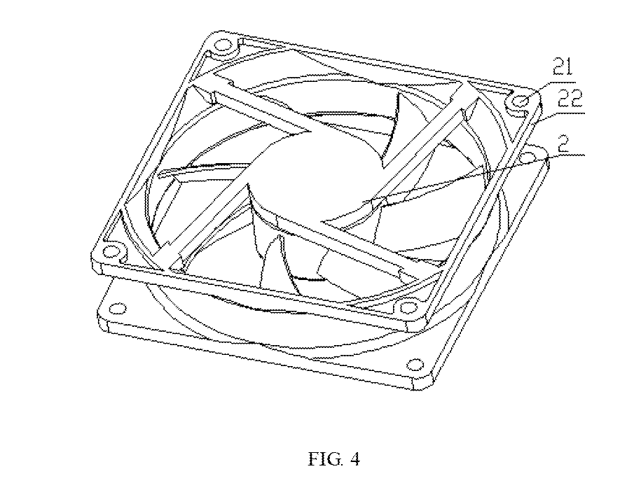

In the example, the housing 1 comprises the upper housing, the lower housing, the fan 2 fixed on the upper housing by the screw, where the upper housing and the lower housing are fixed together by the screw. FIG. 3 is a structural diagram of the upper housing, where the upper housing is configured with a screw hole column 12. Combined with FIG. 4, the fan 2 is configured with a screw hole 21 matching with the screw hole 12 of the upper housing, which is a specific example that shows that the fan 2 is fixed in the housing by the screw. It should be understood that the fan 2 is also fixed on the lower housing. As shown in the drawings, the number of the screw hole column 12 and the screw hole 21 are both four, and the screw hole columns 12 and the screw holes 21 are uniformly arranged, which makes the fan firmly fixed in the housing 1. It should be understood that the number of the screw hole column 12 and the screw hole 21 can be different.

A middle part of the upper housing is configured with an air inlet 11, where the air inlet 11 is a circular structure and matches with size of the fan 2. The screw hole column 12 is arranged on an inner side of a surrounding of the air inlet 11 and matches with the fan, which makes the fan 2 convenient to draw the mosquitoes to the housing, and the mosquitoes are blown in the mosquito opening 31. The fan constantly rotates, which dries the air and dehydrates the mosquitoes, thus killing the mosquitoes.

As shown in FIG. 4, two sides of the fan 2 are configured with two relative convex plates, where sizes of the two relative convex plates are same. The screw holes 21 are arranged on the two relative convex plates 22, respectively, which makes the screw holes 21 convenient to match and fix. Reinforcing plates (not shown) are arranged between the two relative convex plate 22, where the reinforcing plates have a strip-shaped structure, which enhances strength of the convex plates 22 and firmness of the screws.

In the example, the fan 2 is connected with the circuit board 5 by wires, and the fan is configured with a groove (not shown), and the wires are place along the groove from an opening of the groove, which avoids wire damage if the wires touch the fan 2. A size of the opening decreases gradually and increases gradually until a size of the opening has no change. A minimum width of the opening is less than a diameter of the wire. The wires are placed in the opening via an extrusion, which prevents the wires from entering into the opening, further limiting the wires.

As shown in FIG. 3, the screw hole column 12 is configured with reinforcing ribs 13, where the reinforcing ribs are triangular structures and has good strength, which improves strength of the screw hole column 12. There are a plurality of the reinforcing ribs 13, and the reinforcing ribs 13 are uniformly arranged on the screw hole column 12, which improves strength of the screw hole column 12.

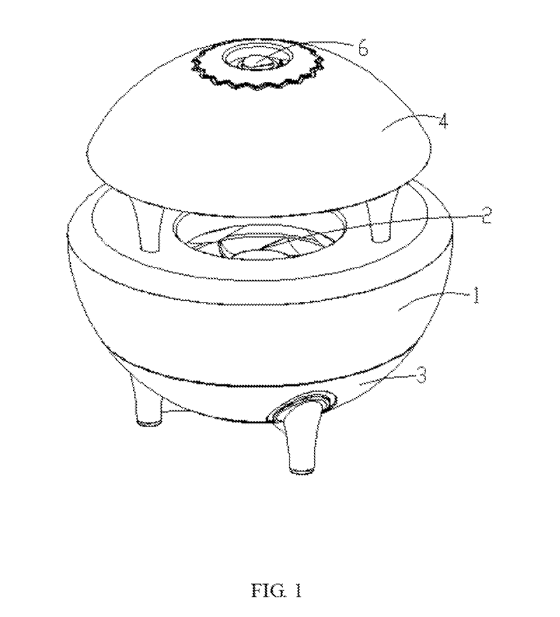

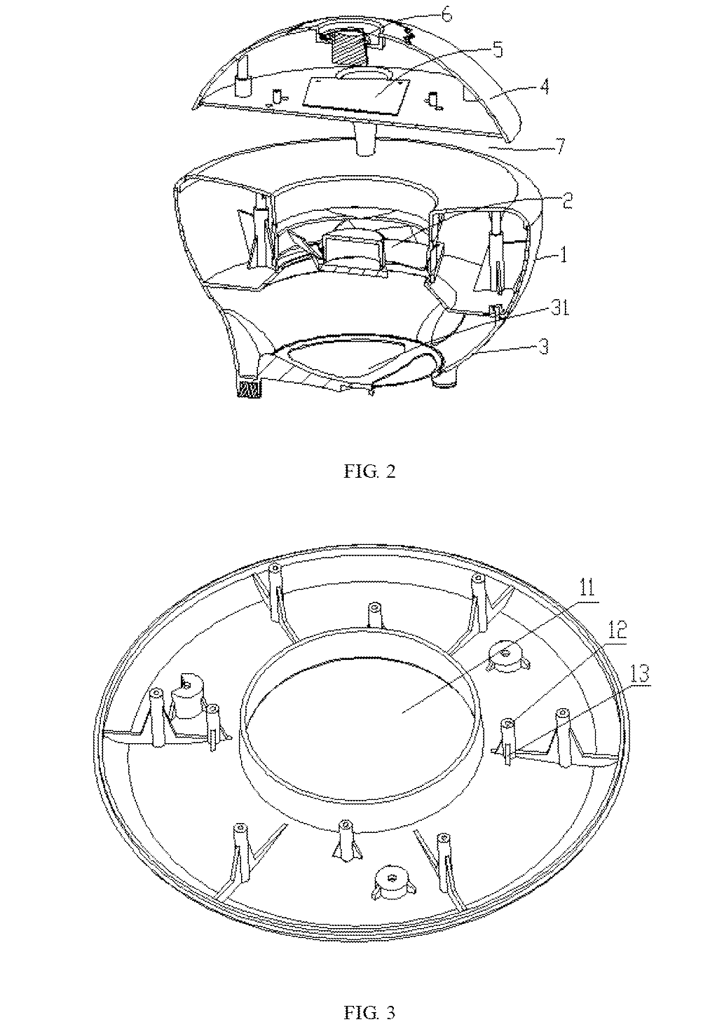

As shown in the FIG. 1 and FIG. 2, the air-flowing type mosquito killing device further comprises a protection element 4 fixed on a top part of the housing 1. An interstice 7 is between the protection element 4 and the housing 1, which makes the mosquitoes convenient to enter into the air inlet 11. A bottom part of the protection element 4 is configured with a plurality of support columns, a height of the support column is a same with a height of the interstice 7, thus, the height of the interstice 7 is controlled by controlling the height of the support column, and the height of the support column is arranged by requirement. The protection element 4 seals the air inlet 11, which avoids debris (such as sundries, fingers of the users and children) entering into the fan 2, further avoiding hurting the users and affecting normal operation of the fan 2.

A top part of the protection element 4 is configured with a switch 6 that controls the air-flowing type mosquito killing device, which makes the air-flowing type mosquito killing device convenient to use.

As shown in the FIG. 1 and FIG. 2, the air-flowing type mosquito killing device further comprises a base 3 fixed on a bottom part of the housing 1, where the base 3 is disassemble from the housing 1. The mosquito opening 31 is arranged on a bottom part of the base 3, which makes for convenient clearing of mosquitoes of the mosquito opening 31. The base 3 is fixed on the bottom part of the housing 1 by clamping.

The present disclosure is described in detail in accordance with the above contents with the specific exemplary examples. However, this present disclosure is not limited to the specific examples. For the ordinary technical personnel of the technical field of the present disclosure, on the premise of keeping the conception of, the technical personnel can also make simple deductions or replacements, and all of which should be considered to belong to the protection scope of the present disclosure.

We claim:

1. An air-flowing type mosquito killing device, comprising:
a housing;
a circuit board;
a lamp;
a fan fixed in the housing by a screw,
wherein the housing corresponding to an air outlet of the fan is configured with a mosquito opening.

2. The air-flowing type mosquito killing device of claim 1, wherein the housing is configured with a screw hole column.

3. The air-flowing type mosquito killing device of claim 2, wherein the fan is configured with a convex plate, and a screw hole is arranged on the convex plate.

4. The air-flowing type mosquito killing device of claim 3, wherein a reinforcing plate is furtherr arranged on the convex plate of the fan.

5. The air-flowing type mosquito killing device of claim 3, wherein the fan is connected with the circuit board by wires, and the fan is configured with a groove, and the wires are place along the groove from an opening of the groove.

6. The air-flowing type mosquito killing device a claim 5, wherein a size of the opening decreases gradually and increases gradually until a size of the opening has no change to form the groove; a minimum width of the opening is less than a diameter of the wire.

7. The air-flowing type mosquito killing device of claim 2, wherein the screw hole column is configured with reinforcing ribs, and the reinforcing ribs are triangular structures.

8. The air-flowing type mosquito killing device of claim 7, wherein a plurality of the reinforcing ribs are uniformly arranged on the screw hole column.

9. The air-flowing type mosquito killing device of claim 2, wherein a number of the screw hole columns are four and are uniformly arranged.

10. The air-flowing type mosquito killing device of claim 2, further comprising a protection element arranged on an air inlet of the fan.
